(19) United States
(12) Patent Application Publication
(10) Pub. No.: US 2023/0171668 A1
(43) Pub. Date: Jun. 1, 2023

(54) COMMUNICATION DEVICE AND COMMUNICATION SYSTEM

(71) Applicant: LAPIS TECHNOLOGY CO., LTD., Kanagawa (JP)

(72) Inventor: YUSUKE NAKAI, KANAGAWA (JP)

(21) Appl. No.: 17/994,186

(22) Filed: Nov. 25, 2022

(30) Foreign Application Priority Data
Nov. 29, 2021 (JP) 2021-193369

(51) Int. Cl. H04W 40/10; H04W 40/08

(52) U.S. Cl. CPC H04W 40/10; H04W 40/08

(57) ABSTRACT

A communication device, which structures a wireless mesh network of a tree structure, determines an initial path on the basis of a RANK value computed from a number of hops from a gateway of each communication device, from information of communication paths acquired from plural other communication devices, and determines a corrected path that is corrected from the initial path, on the basis of a consumed electric power estimated value of an own device that is communicated by the initial path.

### CROSS-REFERENCE TO RELATED APPLICATION

This application is based on and claims priority under 35 USC 119 from Japanese Patent Application No. 2021-193369 filed on Nov. 29, 2021, the disclosures of which are incorporated by reference herein.

### BACKGROUND

### Technical Field

The present disclosure relates to a communication device and a communication system.

### Related Art

There is conventionally known a technique of, at a gateway that structures a mesh network by plural communication devices, selecting a path such that the number of paths going through each communication device is smoothed, on the basis of the number of hops and the number of paths (refer to Japanese Patent Application Laid-Open (JP-A) No. 2016-76903 (Patent Document 1)).

However, in the gateway disclosed in Patent Document 1, because a communication path is determined only by the number of hops and the number of paths, the deviation in the amount of electric power that is consumed at each communication device due to the data transmission intervals differing is large, and there is the problem that the amounts of consumed electric power of the communication devices become large.

### SUMMARY

The present disclosure was proposed in order to solve the above-described problem, and an object thereof is to provide a communication device and a communication system that can reduce the amount of electric power consumed by the communication device.

A communication device relating to the present disclosure, which structures a wireless mesh network of a tree structure, is configured to determine an initial path on the basis of a RANK value computed from a number of hops from a gateway of each of plural other communication devices, from information of communication paths acquired from the plural other communication devices, and determine a corrected path that is corrected from the initial path, on the basis of an estimate of consumed electric power of the communication device that is communicated by the initial path.

In accordance with the present disclosure, there is the effect that the consumed amount of electric power of a communication device can be reduced.

### BRIEF DESCRIPTION OF THE DRAWINGS

FIG. 1 is a schematic structural drawing of a communication system relating to an embodiment of the present invention;

FIG. 2 is a schematic block drawing of a communication device relating to the embodiment of the present invention;

FIG. 3 is a schematic block drawing of a gateway relating to the embodiment of the present invention;

FIG. 4 is an explanatory drawing for explaining transmission of DIO data relating to the embodiment of the present invention;

FIG. 5 is an explanatory drawing for explaining transmission of DAO data relating to the embodiment of the present invention;

FIG. 6 is an explanatory drawing for explaining an example of the data format of communication data relating to the embodiment of the present invention;

FIG. 7 is an explanatory drawing for explaining an example of a case in which transmission interval values are inputted in the data format of the communication data illustrated in FIG. 6;

FIG. 8 is an explanatory drawing for explaining an example of initial paths and transmission interval values relating to the embodiment of the present invention;

FIG. 9 is an explanatory drawing for explaining an example of corrected paths relating to the embodiment of the present invention; and

FIG. 10 is an explanatory drawing for explaining an example of corrected paths, which have been corrected further from the corrected paths illustrated in FIG. 9, and the transmission interval values.

### DETAILED DESCRIPTION

### Embodiment

An example of an embodiment of the present disclosure is described hereinafter with reference to the drawings. Note that structural elements and portions that are the same or equivalent are denoted by the same reference numerals in the respective drawings. Further, dimensional proportions in the drawings are exaggerated for convenience of explanation, and there are cases in which they differ from actual proportions.

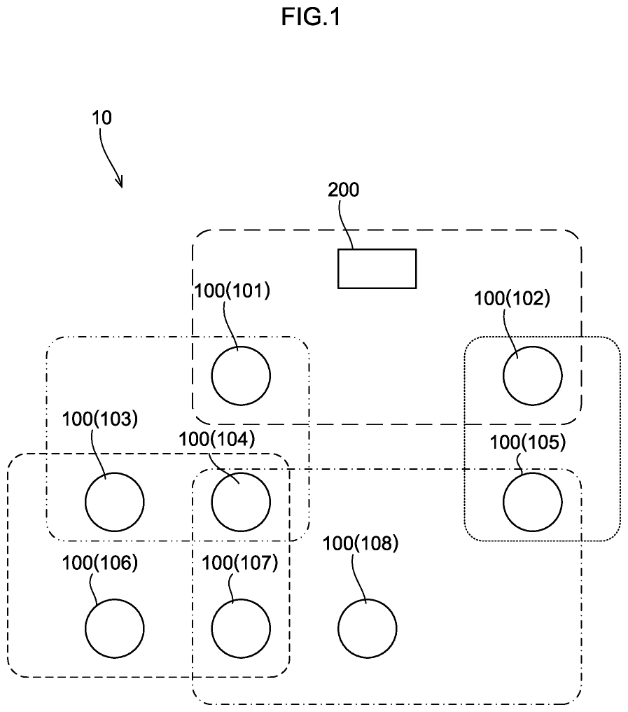

An example of a communication system 10 relating to the present embodiment is described by using FIG. 1.

FIG. 1 is a drawing illustrating an example of the schematic structure of the communication system 10 relating to the present embodiment. As illustrated in FIG. 1, the communication system 10 relating to the present embodiment is structured by a wireless mesh network that includes plural communication devices 100 (101˜108) and a gateway 200. The communication devices 100 are devices that transmit and receive data with the other communication devices 100 and with the gateway 200 in the wireless mesh network. The gateway 200 is the device that is the entrance to the wireless mesh network 10, and is a device that transmits and receives data to and from the communication devices 100 and transmits and receives data to and from other networks as well. Further, in the present embodiment, the communication devices 100 are also called nodes.

The dashed lines in FIG. 1 illustrate the ranges in which communication of the respective communication devices 100 and the gateway 200 is possible. Namely, the dashed line shows that the communication devices 100 and the gateway 200 that are surrounded by that dashed line can communicate with one another. For example, the gateway 200 can communicate with the communication device 101 and the communication device 102. The communication device 101 can communicate with the gateway 200, the communication device 102, the communication device 103 and the communication device 104. Further, the communication device 102 can communicate with the gateway 200, the communication device 101 and the communication device 105. The communication device 103 can communicate with the communication device 101, the communication device 104, the communication device 106 and the communication device 107. Further, the communication device 104 can communicate with the communication device 101, the communication device 103, the communication device 105, the communication device 106, the communication device 107 and the communication device 108. The communication device 105 can communicate with the communication device 102, the communication device 104, the communication device 107 and the communication device 108. Further, the communication device 106 can communicate with the communication device 103, the communication device 104 and the communication device 107. Moreover, the communication device 107 can communicate with the communication device 103, the communication device 104, the communication device 105, the communication device 106 and the communication device 108.

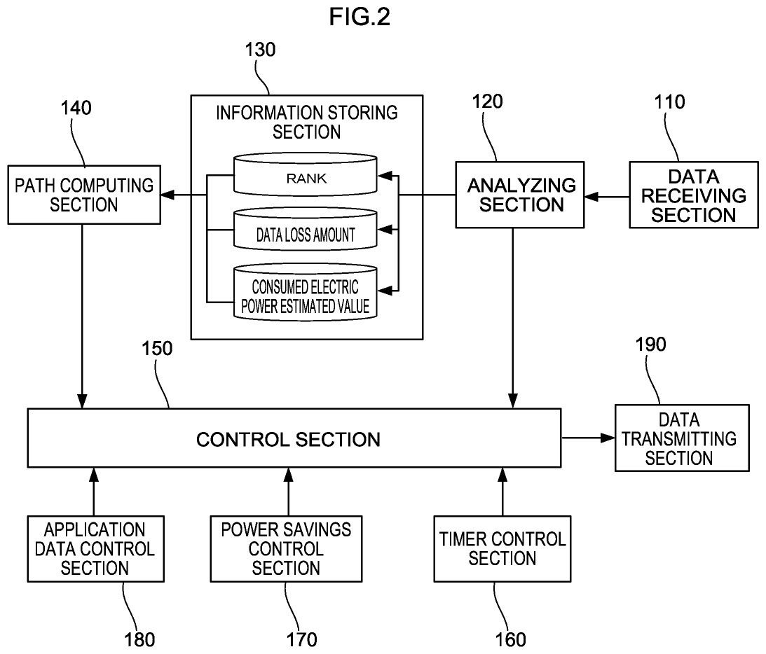

FIG. 2 is a block drawing illustrating hardware structures of the communication device 100 relating to the present embodiment.

As illustrated in FIG. 2, the communication device 100 has a data receiving section 110, an analyzing section 120, an information storing section 130, a path computing section 140, a control section 150, a timer control section 160, a power savings control section 170, an application data control section 180 and a data transmitting section 190.

The data receiving section 110 receives information of the peripheral communication devices 100, and communication data such as application data and the like. Here, information of the communication device 100 is the address, RANK, sequence number, operation mode and the like. Further, the application data is an application that is transmitted and received at the wireless mesh network. For example, in a case in which the wireless mesh network is a network that transmits and receives detected data of a sensor, the application data is the detected data of the sensor.

The analyzing section 120 analyzes the communication data received by the data receiving section 110. As a result of analyzing, the analyzing section 120 classifies the data into data that includes information of the peripheral communication devices 100, and other data such as application data and the like. The data that includes the information of the peripheral communication devices 100 is transmitted to the information storing section 130. Data other than this is transmitted to the control section 150.

From the data that is transmitted from the analyzing section 120, the information storing section 130 stores a RANK, a data loss amount and a consumed electric power estimated value, for each of the communication devices 100. This data includes not only the RANK and the like of the peripheral communication devices 100, but also data such as the RANK and the like of the own device. The RANK, data loss amount and consumed electric power estimated value are described later. The RANK, the data loss amount and the consumed electric power estimated value are transmitted to the path computing section 140.

The path computing section 140 computes the communication path to the gateway 200, on the basis of the RANK, the data loss amount and the consumed electric power estimated value that are transmitted from the information storing section 130. Then, the path computing section 140 transmits the computed communication path to the control section 150. Computing of the communication path is described later.

The control section 150 generates data (DIO data that is described later and communication data), on the basis of information that are transmitted from the analyzing section 120, the path computing section 140, the timer control section 160 and the application data control section 180. Then, the control section 150 transmits the generated data to the data transmitting section 190.

The timer control section 160 manages a timer set time for reporting information of that communication device 100 itself (the own device) to the periphery. When this time arrives, the timer control section 160 notifies the control section 150 that the time for reporting the information of the own device to the periphery has arrived. The control section 150 that receives this notice transmits DIO data to the peripheral communication devices 100 as will be described later. The set time of the timer for notifying the periphery of the information of the own device is set by the control section 150. The control section 150 sets this timer set time to be long in a case in which the probability of successful transmission of the DIO data that is described later is high, and sets the timer set time to be short in a case in which the probability of successful transmission of the DIO data is low. Namely, in a case in which communication is stable, the timer set time is long, and in a case in which communication is not stable, the timer set time is short.

The power savings control section 170 carries out control for transitioning the own device into a sleep state.

In a case in which the application data control section 180 acquires data for transmission to the gateway 200 (e.g., detected data transmitted from the sensor), the application data control section 180 transmits that data to the control section 150. The data transmitting section 190 transmits the communication data, which was transmitted from the control section 150, to the other communication devices 100 and the gateway 200.

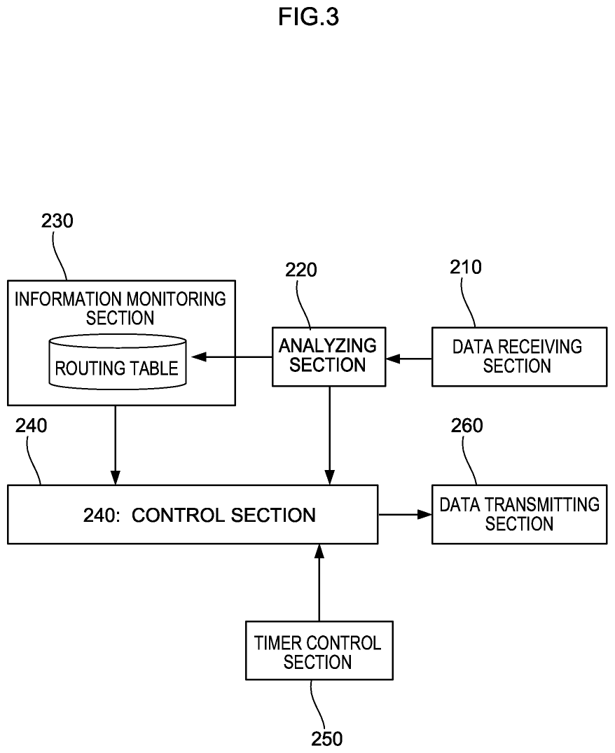

FIG. 3 is a block drawing illustrating hardware structures of the gateway 200 relating to the present embodiment.

As illustrated in FIG. 3, the gateway 200 has a data receiving section 210, an analyzing section 220, an information monitoring section 230, a control section 240, a timer control section 250 and a data transmitting section 260.

The data receiving section 210 receives information of the peripheral communication devices 100, and communication data such as application data and the like.

The analyzing section 220 analyzes the communication data received by the data receiving section 210. As a result of the analyzing, the analyzing section 220 classifies the data into data that includes the communication paths constructed between the communication devices 100, and data other than that such as application data and the like. The data that includes the communication paths is transmitted to the information monitoring section 230. Data other than this is transmitted to the control section 240.

The information monitoring section 230 stores and updates the communication paths of all of the communication devices 100 that have been transmitted from the analyzing section 220. Then, the information monitoring section 230 transmits the latest communication paths to the control section 240.

The control section 240 generates data (DIO data that is described later and communication data) on the basis of the information transmitted from the data analyzing section 220, the information monitoring section 230 and the timer control section 250. Then, the control section 240 transmits the data to the data transmitting section 190.

The timer control section 250 manages the timer set time for reporting information of the gateway 200 itself (the own device) to the periphery. When this time arrives, the timer control section 250 notifies the control section 240 that the time for reporting information of the own device to the periphery has arrived. The control section 240 that receives this notice transmits DIO data to the peripheral communication devices 100 as will be described later. The set time of the timer for notifying the periphery of the information of the own device is set by the control section 240. The control section 240 sets this timer set time to be long in a case in which the probability of successful transmission of the DIO data that is described later is high, and sets the timer set time to be short in a case in which the probability of successful transmission of the DIO data is low. Namely, in a case in which communication is stable, the timer set time is long, and in a case in which communication is not stable, the timer set time is short.

The data transmitting section 260 transmits the communication data, which was transmitted from the control section 240, to the other communication devices 100 and a server (not illustrated).

Computation of the communication path is described next. First, computing of the initial path of the communication path is described.

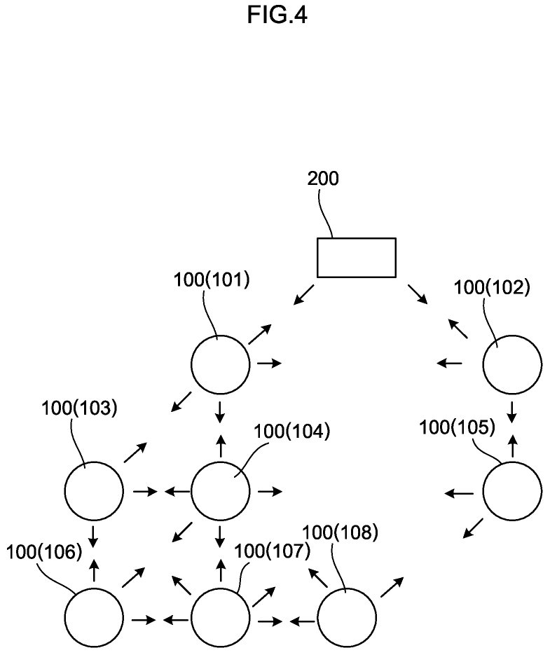

In order to inform the peripheral communication devices 100 of information (the address, RANK, sequence number, operation mode and the like) of the own device, the communication device 100 or the gateway 200 (the data transmitting section 190, the data transmitting section 260) multicasts the DIO data (see FIG. 4). The DIO data is transmitted (the data transmitting section 190) by using a trickle timer (the timer control section 160). At the trickle timer, the timer set time is long during the time when network communication is stable, and is short during the time when network communication is unstable.

When the communication device 100 grasps information of the peripheral communication devices 100, RANKs (256×(n+1)) are allocated in order from the gateway 200, to the relaying communication devices 100 of the wireless mesh network (in the present example, the communication device 101, the communication device 102, the communication device 103, the communication device 104, the communication device 105) and to the terminal communication devices 100 (in the present example, the communication device 106, the communication device 107, the communication device 108). Here, n is the number of hops from the gateway 200. The RANK of the gateway 200 is 256. The smaller the RANK of the communication device 100, the closer that communication device 100 is to the gateway 200. In the case of the network of FIG. 1, the communication devices 101, 102 have RANK 512, and the communication device 103, the communication device 104 and the communication device 105 have RANK 768, and the communication device 106, the communication device 107 and the communication device 108 have RANK 1024.

Each communication device 100 (path computing section 140) carries out parent selection on the basis of information that are RANK values and data loss amounts. Here, the data loss amount is the cardinal number of the ordinal number of which time the transmission of the application data, which was transmitted to the gateway 200, succeeded. Note that the data loss amount is not limited to the number of the time at which transmission of the application data was successful, and may be the success rate of transmission or the like.

An example of parent selection at the communication device 106 is described.

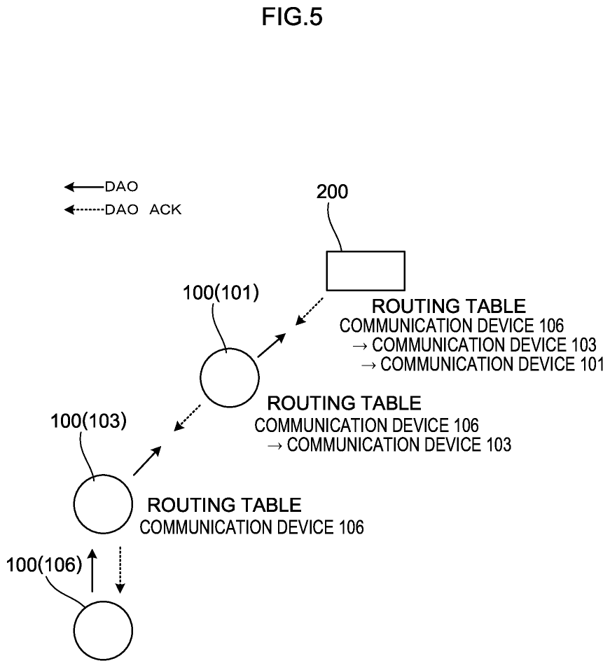

At the time of carrying out parent selection at the communication device 106, the communication device 106 adds the RANK value and the data loss amount, and selects the device whose value is low as the parent. When the parent is selected at the communication device 106, the communication device 106 unicasts (FIG. 5) the DAO data to the parent (to the communication device 103 in a case in which the communication device 103 is the parent). When the communication device 103 receives the DAO data from the communication device 106, the communication device 103 registers the communication device 106 as a child in a routing table of the communication device 103, and unicasts the DAO data to the communication device 101 that is the parent of the communication device 103. Similarly, the communication device 101 also registers the DAO data in a routing table, and unicasts the DAO data to the gateway 200.

When the gateway 200 receives communication path information data, the gateway 200 registers the path in its own routing table (the information monitoring section 230) in order from the terminal communication device 106, the communication device 103 and the communication device 101. The gateway 200 transmits an ACK (FIG. 5) to the communication devices 100 (the communication device 101, the communication device 103 and the communication device 106) from which the communication path information data has been transmitted.

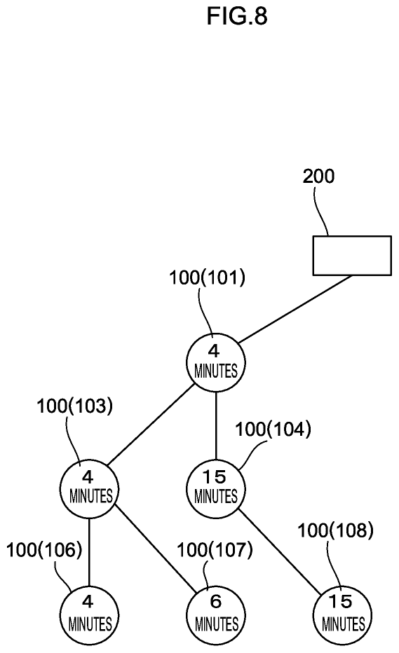

The other communication devices 100 as well carry out similar processings, and ultimately, the path information of all of the communication devices 100 are registered in the routing table (the information monitoring section 230) of the gateway 200 (refer to FIG. 8 that is described later).

In a case in which the terminal communication device 100 of the network (the communication device 106, the communication device 107 and the communication device 108) transmits application data to the gateway 200, the data is transmitted on the path of the path information registered in the gateway 200.

Further, a sensor or the like, which is the source of data of an application that is transmitted and received on the network, is connected (not illustrated) to the terminal communication device 100 of the network (the communication device 106, the communication device 107 and the communication device 108) among the communication devices 100.

Note that this computing of the initial path is communication protocol prescribed in non-patent document “RFC6550 ‘RPL: IPv6 Routine Protocol for Low-Power and Lossy Networks”’.

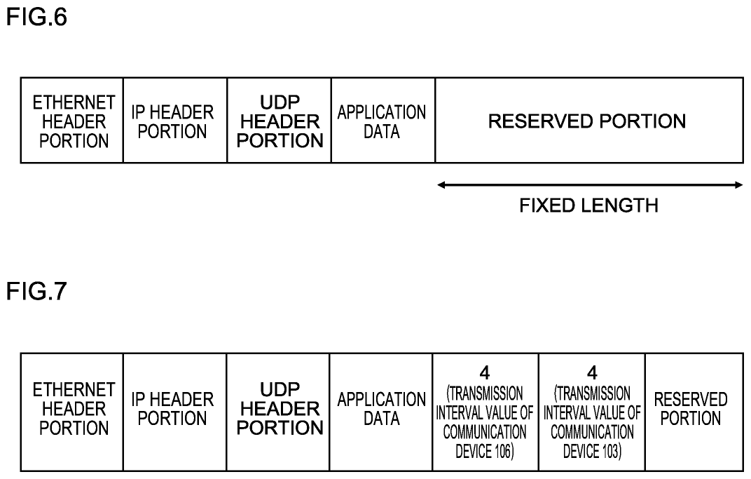

Re-computing of the communication path is described next by using FIG. 6 through FIG. 10. When application data is transmitted from the communication device 106, the communication device 107 or the communication device 108 in FIG. 1 to the gateway 200, that communication device 100 adds a transmission interval value to the application data so as to generate communication data, and transmits the communication data. Further, the communication device 100 computes a path on the basis of the transmission interval value of the application data that is included in the communication data.

The communication data is described by using FIG. 6 and FIG. 7. As illustrated in FIG. 6, the communication data for transmitting application data to the gateway 200 is structured by a data format that includes an ethernet header portion, an IP header portion, a UDP header portion, the application data, the transmission interval value, and a reserved portion. As described above, the application data is an application that is transmitted and received on a wireless mesh network, e.g., in a case in which the wireless mesh network is a network that transmits and receives detected data of a sensor, the application data is the detected data of the sensor. The transmission interval value is the value of the transmission interval of the communication data of each of the terminal communication devices 100 of the wireless mesh network, and is set by a user or administrator or the like of the wireless mesh network. In the present example, explanation is given with the transmission interval value at the communication device 106 being 4 minutes, the transmission interval value at the communication device 107 being 6 minutes, and the transmission interval value at the communication device 108 being 15 minutes. Namely, description is given of an example in which the application data is transmitted toward the gateway 200 from the terminal communication device 106 of the wireless mesh network each 4 minutes, and is transmitted toward the gateway 200 from the communication device 107 each 6 minutes, and is transmitted toward the gateway 200 from the communication device 108 each 15 minutes. Further, description is given of an example in which, due to the above-described computing of the initial paths, the parent of the terminal communication device 106 is the communication device 103, the parent of the terminal communication device 107 is the communication device 103, and the parent of the terminal communication device 108 is the communication device 104 (see FIG. 8). Note that the lines that connect the respective communication devices 100 and the gateway 200 in the drawings are lines that illustrate the paths. Further, “0” is inputted in the reserved portion that is for input of the transmission interval value of the relaying communication device 100. Namely, at a low region of the communication data, there is provided an empty region of a fixed length of an amount that can store a number of transmission interval values which number is equal to the number of the relaying communication devices 100 that are passed through from the terminal communication device 100 to the gateway 200 of the wireless mesh network that is supposed. This empty region is used as a reserved portion for storing the transmission interval values of the relaying communication devices 100, and a specific numerical value that is determined in advance, e.g., “0”, is inputted thereto as the initial value. The communication data not only transmits the application data, but also has the function of notifying the relaying communication devices 100 of the transmission interval value of the application data that is set at the terminal communication device 100 (in the present example, the communication device 106, the communication device 107, the communication device 108).

For example, the communication device 106 (the control section 150) generates communication data in which the transmission interval value “4” is added to the application data, and (the transmitting section 190) transmits the communication data to the communication device 103 that is the parent communication device 100. Similarly, the communication device 107 (the control section 150) also generates communication data in which the transmission interval value “6” is added to the application data. Due to the transmission interval value being added, the checksum value of the UDP header portion changes, and therefore, the checksum value is recomputed and set. Then, the communication device 107 (the transmitting section 190) transmits the communication data to the communication device 103 that is the parent communication device 100. The communication device 103 that has received the two communication data searches for a “0”, which has been inputted in the reserved portion, in the lowest region of the communication data. If a numerical value that is not “0” is found, the communication device 103 inputs (FIG. 7) the smaller numerical value “4” among the received communication data “4” and “6” to the next-lowest region after the numerical value that is not “0”, as the transmission interval value of the own device. Then, the communication device 103 (the transmitting section 190) transmits the communication data to the communication device 101 that is the parent. Here, in the case of the communication device 100 that is the parent of plural communication devices 100, the smallest value among the transmission interval values of the plural communication devices 100 is stored as the transmission interval value of the own device. Namely, the communication device 103, which is the parent of the communication device 106 whose transmission interval value is 4 minutes and the communication device 107 whose transmission interval value is 6 minutes, treats the 4-minute transmission interval value of the communication device 106, which is the smaller transmission interval value, as the transmission interval value of the own device.

Similarly, the communication device 108 also generates communication data in which the transmission interval value “15” is added to the application data, and transmits the communication data to the communication device 104 that is the parent communication device 100. The communication device 104 that has received the communication data searches for a “0”, which has been inputted in the reserved portion, in the low digits of the communication data. If a digit that is not “0” is found, the communication device 104 inputs the received communication data “15” to the next-lowest digit after the portion that is not “0”, as the transmission interval value of the own device. Then, the communication device 104 transmits the communication data to the parent communication device 101. The communication device 101, which has received communication data from the communication device 103 and the communication device 104, searches for a “0”, which has been inputted in the reserved portion, in the low digits of the communication data. If a digit that is not “0” is found, the communication device 101 inputs the smaller numerical value “4” among the received communication data of “4” and “15” to the next-lowest digit after the portion that is not “0”, as the transmission interval value of the own device. Then, the communication device 101 transmits the communication data to the gateway 200 that is its parent.

In this way, at the initial path, as illustrated in FIG. 8, the transmission interval value of the communication device 103 is “4”, and the transmission interval value of the communication device 104 is “15”. Further, as illustrated in FIG. 8, the parent of the communication device 107 is the communication device 103.

The greater the transmission interval of the data, the smaller the consumed electric power estimated value of the communication device 100. Therefore, the path computing section 140 computes the consumed electric power estimated value from the total value in which the transmission interval value and the timer set time of the trickle timer of the DIO data are added together. Further, if there is no difference between the data loss amounts thereof, the communication device 100 whose computed total value is large is selected as the parent communication device 100. For example, in a case in which the timer set times of the trickle timers are the same, the communication device 107 (the path computing section 140) selects the communication device 104, whose data transmission interval value is long, as the parent communication device 100. Due thereto, the communication device 100 whose amount of consumed electric power is low can be selected as the parent. The information of this path is included in the DIO data, and is reported to the peripheral communication devices 100. At the time when the communication device 100 selects the parent, the parent is selected by also taking the consumed electric power estimated value into consideration, in addition to the RANK and the packet loss amount that are used in path computation in accordance with the communication protocol prescribed in the conventional, non-patent document “RFC6550 ‘RPL: IPv6 Routine Protocol for Low-Power and Lossy Networks”’. Note that, even if there is a difference in the data loss amounts, the path having the small consumed electric power estimated value may be computed.

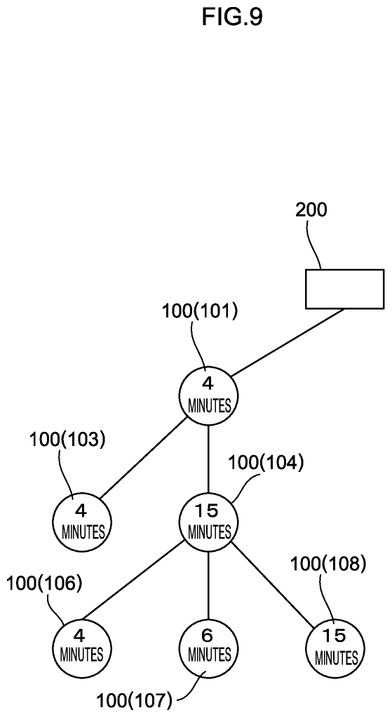

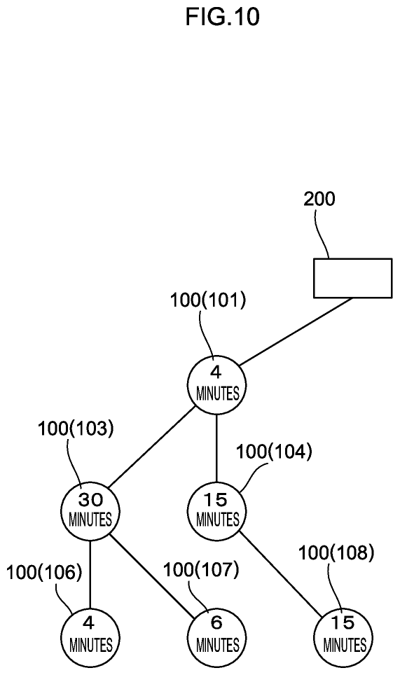

At the communication device 106 as well, accompanying the acquisition of information of the peripheral communication devices 100, the communication device 106 selects the communication device 104, whose transmission interval value is large, as the parent from among the communication devices 100 with which the communication device 106 can communicate (FIG. 9). In this case, because the communication device 100 that is a child of the communication device 103 ceases to exist, the communication device 103 recomputes the transmission interval value “4” of its own device, which is stored in the information storing section 130, to a greater value (e.g., two times the transmission interval value of the communication device 100 whose transmission interval value is the largest), and sets this new transmission interval value. In the present embodiment, the transmission interval value “30”, which is two times the transmission interval value “15” of the communication devices 104 and 108, is set as the new transmission interval value of the communication device 103. Due thereto, when re-computing paths at a predetermined time, the communication device 106 and the communication device 107 again correct the corrected paths, and can select the communication device 103 as the parent (FIG. 10), and can carry out distributed communication. Each communication device 100 devises a savings in electric power (power savings control section 170) by transitioning to a sleep state or transitioning to an active state in accordance with the transmission interval values of the peripheral communication devices 100.

Note that, although the path is computed from the total value of the transmission interval value of the application data and the timer set time of the trickle timer of the DIO data, the present disclosure is not limited to this. The path may be computed by using only the transmission interval value of the application data, or the path may be computed by using only the timer set time of the trickle timer of the DIO data. Further, the re-computing of the communication paths is executed at a specific time interval or at a predetermined time, e.g., at the time when the communication device 100 is added, removed or replaced.

Here, the communication devices 100 and the gateway 200 may be driven by batteries. In a case of driving by batteries, in accordance with the present invention, deviation of the battery consumption of a specific communication device 100 is eliminated, and standardizing of the amounts of consumed electric power of the respective communication devices 100 is devised, and therefore, the life of the entire communication system 10 becomes longer.

What is claimed is:

1. A communication device that structures a wireless mesh network of a tree structure, wherein the communication device is configured to:
determine an initial path on the basis of a RANK value computed from a number of hops from a gateway of each of a plurality of other communication devices, from information of communication paths acquired from the plurality of other communication devices, and
determine a corrected path that is corrected from the initial path, on the basis of an estimate of consumed electric power of the communication device that is communicated by the initial path.

2. The communication device of claim 1, wherein the estimate of the consumed electric power is determined on the basis of a transmission interval of application data that is transmitted toward the gateway from a terminal communication device of a communication path.

3. The communication device of claim 1, wherein the estimate of the consumed electric power is determined on the basis of a transmission interval of application data that is transmitted toward the gateway from a terminal communication device of a communication path, and a transmission interval of data for notifying peripheral communication devices of information about the communication device that is transmitted from the communication device to the peripheral communication devices.

4. The communication device of claim 2, wherein the transmission interval of the communication device is added to the application data that is transmitted to the gateway from the terminal communication device of the communication path, and the data is transmitted to other communication devices.

5. The communication device of claim 3, wherein the transmission interval of the communication device is added to the application data that is transmitted to the gateway from the terminal communication device of the communication path, and the data is transmitted to other communication devices.

6. The communication device of claim 4, wherein
a data format in which the application data is transmitted includes, at a low region thereof, a reserved portion, which is for inputting the transmission interval of a relaying communication device,
a predetermined, specific numerical value is inputted in the reserved portion as an initial value, and
a numerical value, which is not the specific numerical value, is searched for in a lowest region of the data format, and, in a case in which a numerical value that is not the specific numerical value is found, the transmission interval of the communication device is added in place of the specific numerical value in a next-lowest region after the numerical value that is not the specific numerical value.

7. The communication device of claim 1, wherein
the estimate of the consumed electric power is re-computed at a predetermined time, and
a corrected path is corrected on the basis of the estimate of the consumed electric power that is re-computed.

8. The communication device of claim 2, wherein
the estimate of the consumed electric power is re-computed at a predetermined time, and
a corrected path is corrected on the basis of the estimate of the consumed electric power that is re-computed.

9. The communication device of claim 3, wherein
the estimate of the consumed electric power is re-computed at a predetermined time, and
a corrected path is corrected on the basis of the estimate of the consumed electric power that is re-computed.

10. The communication device of claim 1, wherein the communication device is driven by a battery.

11. The communication device of claim 2, wherein the communication device is driven by a battery.

12. The communication device of claim 3, wherein the communication device is driven by a battery.

13. A communication system comprising:
the communication device of claim 1; and
the gateway.

14. A communication system comprising:
the communication device of claim 2; and
the gateway.

15. A communication system comprising:
the communication device of claim 3; and
the gateway.
